(19) United States
(12) Patent Application Publication
(10) Pub. No.: US 2003/0105855 A1
(43) Pub. Date: Jun. 5, 2003

(54) Usage-based billing method and system for computer networks

(75) Inventor: Thomas M. Wynnyk, Strathmore (CA)

Correspondence Address: DONALD V. TOMKINS, c/o MILLER THOMSON LLP, 2700, 10155 - 102 STREET, EDMONTON, AB, T5J 4G8, CA

(73) Assignee: BIG PIPE INC.

(21) Appl. No.: 09/991,670

(22) Filed: Nov. 26, 2001

(51) Int. Cl. G06F 15/173

(52) U.S. Cl. 709/224; 709/226

(57) ABSTRACT

A computer-implement method and system are provided for processing traffic flow statistics relating to data transmissions between computers connected to a computer network. Traffic flow statistics gathered from network devices are processed in a series of enhancing steps to produce records for each unique combination of source IP address and destination IP address. The records contain corresponding details for each transmission including amount of data transmitted, transmission start and end times, and identification of the ISPs serving the source and destination computers. The records may be further enhanced to include categorization of each transmission according to the business relationship between the ISPs serving the source and destination computers. The records may be used as desired, such as for network accounting purposes or for generating bills to customers of an ISP, according to billing rates the ISP may assign in relation to the various parameters contained in the records.

### FIELD OF THE INVENTION

The present invention relates to methods and systems of billing computer network users for transmission of data. In particular, the invention relates to billing systems and methods which determine data transmission charges based on the extent and characteristics of actual usage of network facilities and associated expenses.

### BACKGROUND OF THE INVENTION

A computer network is a group of two or more computers or computer systems that are linked together so that they can communicate with each other; i.e., any computer in the network can transmit data to any other computer in the network, and can receive data from any other computer in the network. Computer networks can be used to transmit and receive various types of data, including electronic mail (or “E-mail”) and documents, as well as audio and video signals.

Data is transmitted between computers (or “nodes”) in a computer network according to established protocols. Each computer in the network is assigned a unique numeric identifier commonly called an “IP address” which is used to identify it as either the source or the destination of a particular data transmission. The communication links between computers in a network may take any of several forms, including wired connections, telephone lines, fibre-optic cable, or radio waves. Data is commonly transmitted between linked computers in digital form via “packets” (also called “datagrams”) each carrying a portion of the data to be transmitted, and also carrying the IP address of the destination computer. The data is in the form of “bytes”, each byte being made up of 8 “bits” (or “binary digits”). A given message or data transmission is broken up into many data packets that are transmitted independently, and not necessarily via the same route, from the source computer to the destination computer. The data packets are recompiled to form the desired message upon receipt by the destination computer.

The amount of data that can be transmitted between computers in a network, and the speed of such transmission, will depend on the available capacity of the communication links between the computers. This is commonly expressed in terms of “bandwidth” i.e., the rate of data transfer, commonly measured in kilobits or megabits per second. Each communication link in a computer network will have a fixed available bandwidth. Some types of data transmissions use considerably more bandwidth than others. Simple text messages, such as documents or E-mail, use comparatively small amounts of bandwidth, whereas transmission of graphical images such as photographs requires greater bandwidth. Transmissions of audio and video messages, especially “real-time” audio and video, use particularly large amounts of bandwidth.

A computer network may be a “Local Area Network” (or “LAN”), which links a relatively small group of computers. For instance, LANs are commonly made up of a number of computers within a single building, or a single business or organization; however, LANs can also connect computers separated from each other over a large physical area. Computers within a LAN can communicate with each other, but unless they have an appropriate communications link, they cannot communicate with computers outside the LAN.

In contrast to an LAN, a “Wide Area Network” (or “WAN”) links a comparatively large number of computers over a large geographic area, and typically comprises a number of LANs. Therefore, a computer in a particular LAN connected to a WAN can communicate with any computer in another LAN connected to the WAN. The Internet is an example of a WAN; in fact, the Internet is the largest WAN in the world.

Routers and switches are network devices which are used to make connections between computer networks (e.g., between LANs within a WAN), or between individual computers and a computer network. For purposes of the present disclosure, a router which connects one computer network to another may be referred to as a “net router”, and a router which connects individual computers to a computer network may be referred to as an “edge router”. When a message is being sent from one computer to another computer, there will often be many possible paths or routes which the corresponding data packets could follow to reach the destination computer, because of the great number of computers connected either directly or indirectly within the WAN. Routers determine an optimal path for each data transmission, taking into consideration the status of the network at the time (e.g., current availability status of links in the network; intensity of data traffic), and then direct the message according to the determined path. For example, a message being sent from a source computer to a destination computer in the same town or city might be most efficiently transmitted via a route passing through a distant city or even another country. The packets in the message might take completely different routes to the destination computer; some packets in the message might take short routes, while other packets might follow much longer routes, passing through computers far away from both the source computer and the destination computer.

Network devices such as routers and switches typically record extensive and detailed information relating to the data traffic flowing through them, including, for a given transmission, the source address, destination address, transmission start and end times, and number of data packets transmitted. Such information available from network devices may be generally referred to as “traffic flow statistics”.

An Internet Service Provider (or “ISP”) is an entity that provides customers with access to the Internet; i.e., it provides a connection from a customer's computer to the Internet, through an edge router, so that the customer can communicate with other computers connected to the Internet. The computers of a particular ISP's customers effectively form a LAN, which the ISP connects to the Internet, through net routers. ISPs charge their customers a fee for providing this service. However, determination of an appropriate and equitable fee has proven to be problematic, and commonly used billing methods have disadvantages for both the ISP and the customer.

One common billing method is to charge customers a flat monthly fee for Internet connection, either for a specified total connection time, or for unlimited connection time. When the flat fee is for unlimited connection time, it may be established based on estimates of average Internet usage by customers. However, a flat fee may be inequitable for a customer who uses only a portion of the connection time being paid for in a given billing period, or whose transmissions use less bandwidth than other customers paying the same fee. A flat fee may be inequitable for the ISP in the case of customers whose total connection time and bandwidth usage are greater than the average. In addition, flat-fee billing does not reflect differences in the quantity and quality of service provided, in terms of factors such as volume of data transmitted, transmission duration, bandwidth used, distance between source and destination computers, and whether transmissions were made during peak data traffic periods or during low data traffic periods. For these reasons, a flat fee for Internet connection services tends to result in charges that do not correspond in any consistent way with the nature and quality of service actually provided.

As an alternative or in addition to charging a fixed fee for network connection services, an ISP may charge customers according to the amount of data actually transmitted, usually on a per-gigabyte basis. This billing method may appear equitable at first glance, but as with fixed-fee billing, it does not allow for factors such as distance and route travelled between source and destination computers, and whether transmissions were made during peak data traffic periods or during low data traffic periods. The transmission charge per data unit will be the same regardless of whether the source and destination computers are 10 miles apart or 1,000 miles apart, and regardless of whether the transmissions in question are made during peak data traffic periods such as the middle of the business day, or during low data traffic periods such as the middle of the night.

There are other factors which affect the actual cost of transmitting data between computers in a computer network. One particular factor relates to the relationship between the ISPs serving the source computer and the destination computer, and there are three scenarios which may be considered in this regard.

First, the destination computer may be in the same LAN as the source computer; i.e., both are customers of the same ISP. A data transmission between customers of the same ISP may be categorized as an “on-net” transmission, meaning that the transmission takes place wholly within the ISP's specific network.

In the second scenario, the destination computer is in a different ISP's LAN, but the two ISP's have what is known as a “peering” arrangement; i.e., the two LANs have a direct communication link that allows data to be transmitted directly between the LANs rather than having to travel via other parts of the Internet, which will often entail a more circuitous and thus slower transmission. A data transmission between computers in peering networks may be categorized as an “off-net peering” transmission.

In the third scenario, the destination computer is in a different ISP's LAN, and there is no peering relationship, so the data must be transmitted via other parts of the Internet. This category of data transmission may be referred to as an “off-net transit” transmission.

The actual cost of a transmission will usually be different in each of these scenarios. In the “off-net transit” scenario, there may be a transmission charge from the non-peering ISP. In the “off-net peering” scenario, there may be a transmission charge from the peering ISP, but this charge may be less than the non-peering ISP's charge. In either case, the charge will be an expense typically not incurred in the “on-net” scenario. Known billing methods do not take this factor into consideration. Whether billing is based on a fixed fee or on a charge per unit of transmitted data, an ISP has no way of directly recovering such transmission charges directly from its customers, and therefore must recover them by blending them into the fixed fee or charge per unit of data. As a result, some customers may effectively pay more than their fair share of such transmission charges, while others pay less than their fair share.

The prior art discloses numerous systems and methods directed to billing computer network users based on actual usage of network facilities, as determined from on analysis of traffic flow statistics gathered from network devices such as routers and switches. For example, PCT International Application No. PCT/US98/24963 filed on Nov. 20, 1998 by Wagner (et al.) discloses a billing system and method which processes traffic flow statistics to create transmission records containing information including the IP addresses of the source and destination computers, time and duration of data transmissions, and volume of data transmitted. These transmission records are then used as the basis for bills to be sent to customers. The system and method disclosed in European Patent Application No. 97306849.7 filed on Sep. 9, 1997 by Flavin (et al.) generates similar transmission records from traffic flow statistics. The system may assign cost factors (or “weights”) to the data in a given transmission, according to factors such as the time of transmission, whether the given transmission was transmitted by or received by the customer, and defined classes of users. Other examples of prior art methods and systems directed to usage-based accounting or billing for computer networks, using traffic flow statistics gathered from network devices, include the following:

European Patent Application No. 00302405.6, filed Mar. 24, 2000 by Farrell (et al.)

U.S. Pat. No. 6,208,977, issued on Mar. 27, 2001 to Hernandez (et al.)

Each of the cited prior art methods and systems processes traffic flow statistics available from network devices in a fashion which may useful in certain situations. However, the prior art has not exhausted the possibilities as to how traffic flow statistics may be used to achieve new and useful results. In particular, none of the prior art methods and systems provide for usage-based billing for computer network service according to whether transmissions are on-net, off-net peering, or off-net transit.

For the foregoing reasons, there is a need for an improved method and system for determining billing customers for computer network connections based on actual usage of network resources. More particularly, there is a need for an improved usage-based billing method and system which is capable of identifying and considering one or more selected factors associated with a given network data transmission, based on traffic flow statistics available from routers or other network devices, as well as other characteristics of the data transmission. Furthermore, there is a need for such an improved usage-based billing method and system which facilitate differential billing according to whether a particular transmission may be categorized as on-net, off-net peering, or off-net transit.

### BRIEF SUMMARY OF THE INVENTION

The present invention has the objective of meeting the foregoing needs. In general terms, the invention provides a method and system for processing traffic flow statistics in a series of progressively enhancing steps to produce data transmission records for each unique combination of source IP address and destination IP address, and containing details of each corresponding data transmission including amount of data transmitted, transmission start and end times, and identification of the particular ISPs which serve the source computer and the destination computer. The invention also provides for further enhancement of the data transmission records to include categorization of each transmission according to the relationship between the ISP serving the source computer and the ISP serving the destination computer. The data transmission records thus produced may be used by an ISP in a desired fashion, such as for network accounting purposes or for generating bills to customers of the ISP, in accordance with whatever billing rates which the ISP may choose to assign according to the various parameters contained in the data transmission records.

Accordingly, in one particular aspect the invention is a computer-implemented method of collecting and processing statistical information relating to data transmissions between computers connected to a computer network, said method comprising the steps of:

(a) collecting traffic flow statistics at one or more network devices;

(b) processing the traffic flow statistics, using a first program, to generate a first-stage record for each data transmission, said first-stage record including:

(i) source IP address and destination IP address;

(ii) amount of data transmitted; and

(iii) transmission start time and end time;

(c) transmitting the first-stage records to a second-stage data processing means having data storage means, and storing said first-stage records therein;

(d) sorting the first-stage records, using a second program, to generate second-stage records corresponding to each unique combination of source IP address and destination IP address for a selected sampling period;

(e) transmitting the second-stage records to a third-stage data processing means having data storage means, and storing said second-stage data flow records therein; and

(f) processing the second-stage records, using a third program, to generate third-stage records for each data transmission, said third-stage records including, in addition to the information contained in the second-stage records:

(i) a network identifier corresponding to the source IP address; and

(ii) a network identifier corresponding to the destination IP address.

In the preferred embodiment, the method also comprises the step of processing the third-stage records, using a fourth program, to generate fourth-stage records which identify a service category for each data transmission, said further step including comparing the source network identifier and destination network identifier in each third-stage record against information stored in a database which identifies the relationship between the source network and the destination network. The one or more network devices may include a router. In the preferred embodiment, the sampling period will be approximately 300 seconds.

According to another aspect, the invention is a computer-implemented method of billing users of a computer network for the provision of data transmission services between computers connected to the network, said method comprising the steps of:

(a) collecting traffic flow statistics at one or more network devices;

(b) processing the traffic flow statistics, using a first program, to generate a first-stage record for each data transmission, said first-stage record including:

(i) source IP address and destination IP address;

(ii) amount of data transmitted; and

(iii) transmission start time and end time;

(c) transmitting the first-stage records to one or more first-stage data collectors having data storage means, and storing said first-stage records therein;

(d) sorting the first-stage records, using a second program, to generate second-stage records corresponding to each unique combination of source IP address and destination IP address for a selected sampling period;

(e) transmitting the second-stage records to one or more second-stage data collectors having data storage means, and storing said second-stage data flow records therein;

(f) processing the second-stage records, using a third program, to generate third-stage records for each data transmission, said third-stage records including, in addition to the information contained in the second-stage records:

(i) a network identifier corresponding to the source IP address; and

(ii) a network identifier corresponding to the destination IP address;

(g) processing the third-stage records, using a fourth program to generate fourth-stage records which identify a service category for each data transmission, said further step including comparing the source network identifier and destination network identifier in each third-stage record against information stored in a database which identifies the relationship between the source network and the destination computer; and

(h) assigning a billing rate, per unit of transmitted data, for each service category.

In the preferred embodiment, the billing method of the invention also comprises the steps of determining the total amount of data transmitted in each service category by a selected customer during the sampling period, and generating a bill corresponding to said total amounts of data transmitted in each service category, multiplied by the corresponding assigned billing rates.

The one or more network devices may include a router. In the preferred embodiment, the sampling period will be approximately 300 seconds.

According to a further aspect, the invention is a system for collecting and processing statistical information from network devices relating to data transmissions between computers connected to a computer network, so as to generate transmission-specific records for use in establishing charges to computer users for the provision of data transmission services, said system comprising:

(a) a first-stage data processing means, programmed with a first program, for receiving and processing gathering data traffic statistics from a network device to generate a first-stage record for each data transmission, said first-stage record including:

(i) source IP address and destination IP address;

(ii) amount of data transmitted; and

(iii) transmission start time and end time;

(b) a second-stage data processing means, having data storage means and being programmed with a second program, for receiving and storing first-stage records from said first-stage data processing means, and for sorting the first-stage records to generate second-stage records corresponding to each unique combination of source IP address and destination IP address for a selected sampling period;

(c) a third-stage data processing means, having data storage means and being programmed with a third program, for receiving and storing the second-stage records from the second-stage data processing means, and for processing the second-stage records to generate third-stage records for each data transmission, said third-stage records including, in addition to the information contained in the second-stage records:

(i) a network identifier corresponding to the source IP address; and

(ii) a network identifier corresponding to the destination IP address; and

(d) a fourth-stage data processing means, having a data base containing loaded with reference information regarding the relationship between the source network and the destination network corresponding to each data transmission for which third-stage records have been prepared, said fourth-stage data processing means being programmed with a fourth program, for receiving and storing the third-stage records from the third-stage data processing means, and for processing the third-stage records to generate fourth-stage records which identify a service category for each data transmission.

The one or more network devices may include a router. In the preferred embodiment, the first data processing means is associated with the one or more network devices.

Additional objects, advantages, and novel features of the invention are set out in the following detailed description, which illustrates the preferred and selected alternative embodiments of the invention without restricting the invention thereto. Other objects, advantages, novel features, and alternative embodiments of the invention will become readily apparent to those skilled in the art upon examining the detailed description, or may be learned by practice of the invention.

### BRIEF DESCRIPTION OF THE DRAWINGS

Embodiments of the invention will now be described with reference to the accompanying figures, in which numerical references denote like parts, and in which:

FIG. 1 is a schematic drawing illustrating an ISP connected to ISP customers and to the Internet.

FIG. 2 is a schematic drawing illustrating one possible arrangement of separate ISPs connected to respective customers and to the Internet.

FIG. 3 is a schematic drawing illustrating the system of the invention, according to the preferred embodiment.

### DETAILED DESCRIPTION OF THE PREFERRED EMBODIMENT

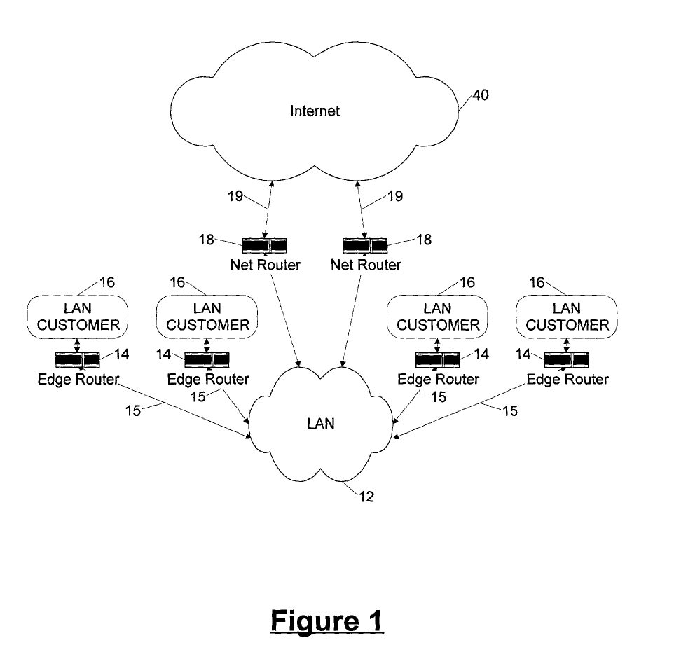

In order to understand the present invention fully, it will be helpful to understand certain basic characteristics of computer networks operated by ISPs and how they may be connected to the Internet. Toward that end, FIG. 1 illustrates how computers users may connect to a WAN such as the Internet 40 through an ISP. As schematically indicated in FIG. 1, computers of customers 16 of a particular ISP are connected to the computer network (or LAN) 12 operated by the ISP via edge routers 14 and communication links 15, and the LAN 12 is connected to the Internet 40 via net routers 18 and communication links 19, as schematically indicated in FIG. 1. When a customer 16 wishes to send a message to another computer, the message is directed by the ISP as appropriate, whether to another customer of the ISP or to a computer outside the ISP network, in which case ISP the message will be sent to its destination through the Internet 40, via one or more net routers 18.

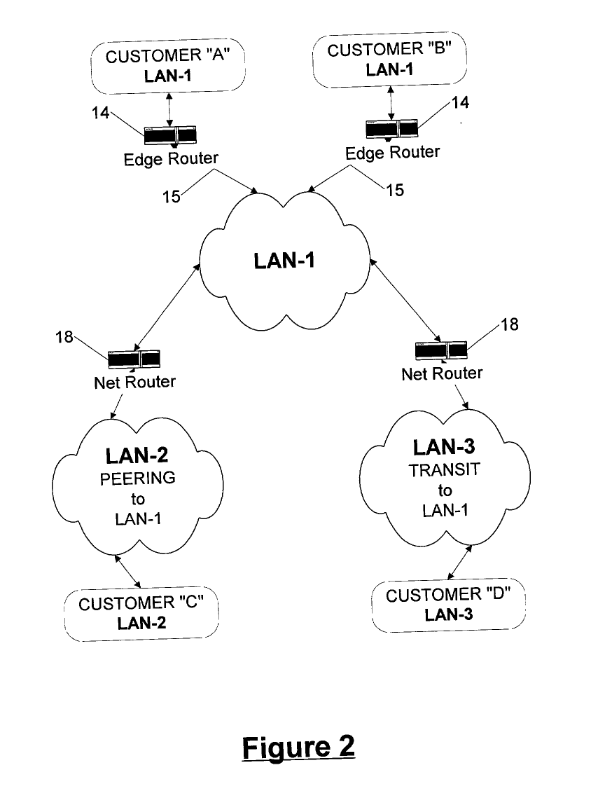

FIG. 2 schematically illustrates possible relationships between networks operated by different ISPs, and the different categories which may be assigned to data transmissions in view of such relationships, in accordance with the present invention:

(a) LAN-1, operated by ISP-1, has various subscribers exemplified for purposes of FIG. 2 by Customer A and Customer B.

(b) LAN-2, operated by ISP-2, has various subscribers as exemplified by Customer C. ISP-2 has a peering arrangement with ISP-1.

(c) LAN-3, operated by ISP-3, has various subscribers as exemplified by Customer D. ISP-3 does not have a peering arrangement with ISP-1; i.e., LAN-3 is a transit network in relationship to LAN-1.

Accordingly, data transmissions to and from a particular customer of ISP-1 may be categorized according to “service categories” defined as follows (the “inbound” and “outbound” categorizations being made with reference to Customer A for purposes of the present illustration):

| | | Service Category |
|---|---|---|
| From | To | (*with reference to Customer A) |
| Customer A | Customer B | Outbound* -- On-Net |
| Customer B | Customer A | Inbound* -- On-Net |
| Customer A | Customer C | Outbound* -- Off-Net -- Peering |
| Customer C | Customer A | Inbound* -- Off-Net -- Peering |
| Customer A | Customer D | Outbound* -- Off-Net -- Transit |
| Customer D | Customer A | Inbound* -- Off-Net -- Transit |

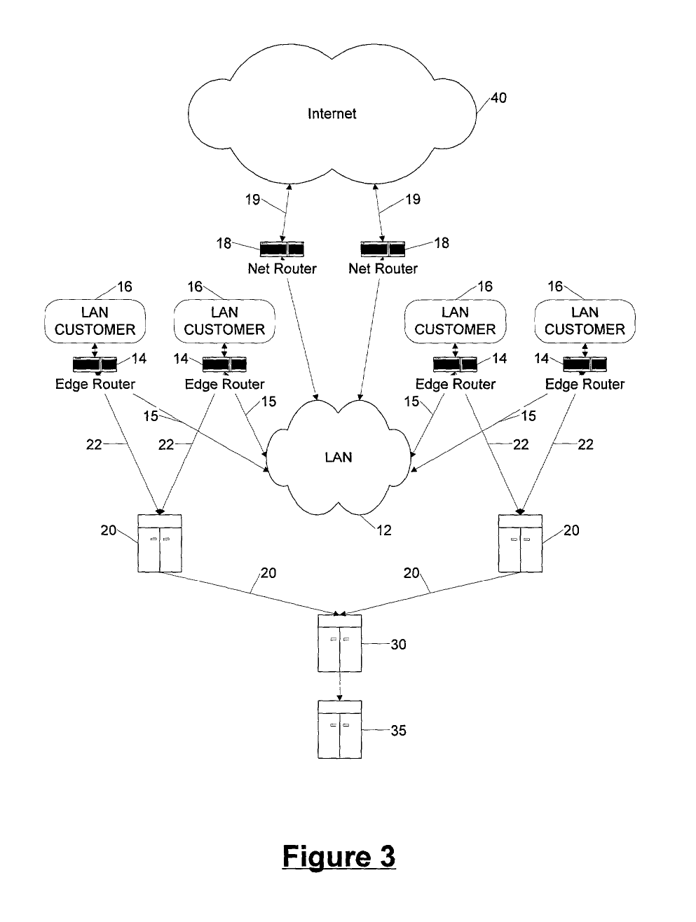

The method and system of the present invention may now be understood having reference to FIG. 3, in which the usage-based billing system of the invention is generally designated by reference numeral 10. The usage-based billing system 10 includes a first-stage data processing means, not shown in FIG. 3, programmed with a first program, for processing traffic flow statistics collected from one or more network devices to generate first-stage records in connection with data transmissions made via the network devices. In the preferred embodiment, the network device or devices from which the traffic flow statistics are collected will include an edge router 14, which record statistics relating to data transmissions made to and from customers 16 of a subject LAN 12, via customer links conceptually denoted by reference numeral 15. Each first-stage record includes the source and destination IP addresses, the amount of data transmitted, and the transmission start and end times for the data transmission in question.

Table 1 illustrates the data fields which may be captured in the first-stage records:

TABLE 1
First-Stage Record Fields

| Field | Description |
|---|---|
| dstaddr | destination IP address |
| srcaddr | source IP address |
| dPkts | Packets sent in duration |
| dOctets | Octets sent in duration |
| First | SysUptime at start of flow |
| Last | and of last packet of flow |
| output | output interface index - CURRENTLY NOT |
| | POPULATED |
| input | input interface index - CURRENTLY NOT |
| | POPULATED |
| tos | Tos - CURRENTLY NOT POPULATED |
| marked_tos | tos of the pkts that exceeded the contract - CURRENTLY |
| | NOT POPULATED |
| ulong extraPkts | packets that exceed the contract - CURRENTLY NOT |
| | POPULATED |
| router_sc | IP address of the router being shortcut - CURRENTLY |
| | NOT POPULATED |

The first-stage records are then transmitted to one or more second-stage data processing means 20 via record transfer links 22. The second-stage data processing means 20 includes data storage means, and is programmed with a second program by means of which the first-stage records are sorted to generate second-stage records corresponding to each unique combination of source IP address and destination IP address over a selected sampling period. In the preferred embodiment, the sampling period is 300 seconds, but sampling periods of different lengths may be used without departing from the essential concept of the invention.

Table 2 illustrates the data fields which may be captured in the second-stage records:

TABLE 2
Second-Stage Record Fields

| Field | Description |
|---|---|
| Srcaddr | Source IP address |
| Dstaddr | Destination IP address |
| Pkts | Packets send in duration |
| Octets | Octets send in duration |
| Flows | Flows sent in duration |
| Starttime | SysUptime at start of flow in UTC seconds |
| Endtime | And of last packet of flow in UTC seconds |
| Activetime | Total active time in ms |

The second-stage records are then transmitted to a third-stage data processing means 30 via record transfer links 32. The third-stage data processing means 20 includes data storage means, and is programmed with a third program by means of which the second-stage records are sorted to generate third-stage records which include identifiers corresponding to the source network (i.e., the computer network in which the source IP address is located) and the destination network (i.e., the computer network in which the destination IP address is located). These identifiers may be referred to as autonomous system numbers, or ASNs.

Table 3 illustrates the data fields which may be captured in the third-stage records:

TABLE 3
Third-Stage Record Fields

| Field | Description |
|---|---|
| Srcaddr | Source IP address |
| Dstaddr | Destination IP address |
| Octets | Octets send in duration |
| Starttime | Start time for the summarization of this record in |
| | yyyy_mm_dd.hhmm |
| Endtime | End time for the summarization of the record in |
| | yyyy_mm_dd.hhmm |
| src_as | Autonomous system number of the source, either |
| | origin or peer |
| dst_as | Autonomous system number of the destination, either |
| | origin or peer |
| Input_interface | Input interface of the flow |
| Output_interface | Output interface of the flow |

The third-stage records are then transmitted to a fourth-stage data processing means 35 which includes a data base and is programmed with a fourth program. The data base is loaded with reference information regarding the relationship between the source network and the destination network corresponding to each data transmission for which third-stage records have been prepared; i.e., same network, peering networks, or transit. The fourth-stage data processing means 35 compares the third-stage records against the information in the data base to generate fourth-stage records which assign a service category, as previously defined and explained herein, to each data transmission. The service category for each data transmission will always be with reference to a specific computer, either the source computer or the destination computer.

The fourth-stage records may then be used or further processed as desired by a user of the invention, such as the ISP which operates the subject LAN 12, for purposes such as network accounting purposes and for billing the ISP's customers 16. For example, the ISP may choose to assign different billing rates for each service category. In that case, the ISP would general bills which give totals for data transmissions in each service category during a particular billing period, and apply the corresponding billing rates to give a total data transmission charge. The information available from the fourth-stage records would also enable the ISP to bill services based on other usage parameters in addition to service categories; e.g., transmission time (peak or off-peak), packet size, and packet route.

The practical advantages and usefulness of the records produced in accordance with the invention may be particularly illustrated by means of a few examples. In one exemplary billing model, an ISP might assign different billing rates, based on the amount of data transmitted (e.g., per megabit), to each of the service categories. A customer's bill on this basis would be easily determined by aggregating the number of megabits in each service category for a selected billing period (e.g., monthly), multiplying the aggregrated subtotals by their corresponding assigned rates, and adding the results to give a grand total. It is readily apparent that many variations on this theme are possible. The ISP might prefer, for example, to set a single rate for all off-net services, regardless of whether the services were peering or transit. The ISP could also set a single rate for all on-net services, without differentiation as to whether the transmissions in question were inbound or outbound. The ISP could assign rates to a given service category according to variable parameters such as the time period in which corresponding data transmissions occur (i.e., during peak hours or off-peak hours), packet size, or packet route. Whatever billing rate structure may be selected, generation of corresponding customer bills is easily accomplished by sorting and aggregating data from the records produced in accordance with the invention, using data processing methods well known in the art.

In an alternative billing model, customers may be billed according to bandwidth used, rather than total megabits transmitted. The ISP may assign particular billing rates per unit of bandwidth usage (e.g., megabits per second) for each service category, or for a group of service categories, and these rates could be further refined according to variables such as transmission time or packet size. Generation of customer bills on a bandwidth-usage basis would once again be a straightforward exercise using well-known data processing methods, including the additional but simple step of calculating data flow rates (i.e., bandwidth usage) from the information provided by the records produced in accordance with the invention.

Any of the billing rate structures generally described above could also be used in conjunction with features such as minimum usage commitments and volume-usage discount incentives. For example, an ISP might offer an arrangement with an ISP whereby the customer commits to pay for a minimum amount of data transmitted (i.e., megabits) or bandwidth used (i.e., megabits per second) during a specified billing period. There could conceivably be a single commitment level which could be met by total usage in all service categories, or individual commitment levels in particular service categories. Billing plans of this nature could provide for discounts for usage in excess of the commitment levels, with different discount rates for each service category as may be desired.

The foregoing are only a few examples of network billing rate structures which are made conveniently possible by use of data transmission records produced in accordance with the present invention. These few examples are nonetheless sufficient to demonstrate the considerable flexibility which such records may provide for ISPs in developing network billing plans which more closely reflect actual usage of network services, and which may give ISP customers a broad range of plans from which to choose, to suit the customers' particular network usage requirements.

It will be readily seen by those skilled in the art that various modifications of the present invention may be devised without departing from the essential concept of the invention, and all such modifications are intended to be included in the scope of the claims appended hereto.

The embodiments of the invention in which an exclusive property or privilege is claimed are defined as follows:

1. A computer-implemented method of collecting and processing statistical information relating to data transmissions between computers connected to a computer network, said method comprising the steps of:
(a) collecting traffic flow statistics at one or more network devices;
(b) processing the traffic flow statistics, using a first program, to generate a first-stage record for each data transmission, said first-stage record including:
(i) source IP address and destination IP address;
(ii) amount of data transmitted; and
(iii) transmission start time and end time;
(c) transmitting the first-stage records to a second-stage data processing means having data storage means, and storing said first-stage records therein;
(d) sorting the first-stage records, using a second program, to generate second-stage records corresponding to each unique combination of source IP address and destination IP address for a selected sampling period;
(e) transmitting the second-stage records to a third-stage data processing means having data storage means, and storing said second-stage data flow records therein; and
(f) processing the second-stage records, using a third program, to generate third-stage records for each data transmission, said third-stage records including, in addition to the information contained in the second-stage records:
(i) a network identifier corresponding to the source IP address; and
(ii) a network identifier corresponding to the destination IP address.

2. The method of claim 1 comprising the further step of processing the third-stage records, using a fourth program to generate fourth-stage records which identify a service category for each data transmission, said further step including comparing the source network identifier and destination network identifier in each third-stage record against information stored in a database which identifies the relationship between the source network and the destination network.

3. The method of claim 1 wherein the one or more network devices includes a router.

4. The method of claim 1 wherein the sampling period is approximately 300 seconds.

5. A computer-implemented method of billing users of a computer network for the provision of data transmission services between computers connected to the network, said method comprising the steps of:
(a) collecting traffic flow statistics at one or more network devices;
(b) processing the traffic flow statistics, using a first program, to generate a first-stage record for each data transmission, said first-stage record including:
(i) source IP address and destination IP address;
(ii) amount of data transmitted; and
(iii) transmission start time and end time;
(c) transmitting the first-stage records to one or more first-stage data collectors having data storage means, and storing said first-stage records therein;
(d) sorting the first-stage records, using a second program, to generate second-stage records corresponding to each unique combination of source IP address and destination IP address for a selected sampling period;
(e) transmitting the second-stage records to one or more second-stage data collectors having data storage means, and storing said second-stage data flow records therein;
(f) processing the second-stage records, using a third program, to generate third-stage records for each data transmission, said third-stage records including, in addition to the information contained in the second-stage records:
(i) a network identifier corresponding to the source IP address; and
(ii) a network identifier corresponding to the destination IP address;
(g) processing the third-stage records, using a fourth program to generate fourth-stage records which identify a service category for each data transmission, said further step including comparing the source network identifier and destination network identifier in each third-stage record against information stored in a database which identifies the relationship between the source network and the destination computer; and
(h) assigning a billing rate, per unit of transmitted data, for each service category.

6. The method of claim 5, further comprising the step of determining the total amount of data transmitted in each service category by a selected customer during the sampling period.

7. The method of claim 6, further comprising the step of generating a bill corresponding to said total amounts of data transmitted in each service category, multiplied by the corresponding assigned billing rates.

8. The method of claim 5 wherein the one or more network devices includes a router.

9. The method of claim 5 wherein the sampling period is approximately 300 seconds.

10. A system for collecting and processing statistical information from network devices relating to data transmissions between computers connected to a computer network, so as to generate transmission-specific records for use in establishing charges to computer users for the provision of data transmission services, said system comprising:
(a) a first-stage data processing means, programmed with a first program, for receiving and processing gathering data traffic statistics from a network device to generate a first-stage record for each data transmission, said first-stage record including:
(i) source IP address and destination IP address;
(ii) amount of data transmitted; and
(iii) transmission start time and end time;
(b) a second-stage data processing means, having data storage means and being programmed with a second program, for receiving and storing first-stage records from said first-stage data processing means, and for sorting the first-stage records to generate second-stage records corresponding to each unique combination of source IP address and destination IP address for a selected sampling period;
(c) a third-stage data processing means, having data storage means and being programmed with a third program, for receiving and storing the second-stage records from the second-stage data processing means, and for processing the second-stage records to generate third-stage records for each data transmission, said third-stage records including, in addition to the information contained in the second-stage records:
(i) a network identifier corresponding to the source IP address; and
(ii) a network identifier corresponding to the destination IP address; and
(d) a fourth-stage data processing means, having a data base containing loaded with reference information regarding the relationship between the source network and the destination network corresponding to each data transmission for which third-stage records have been prepared, said fourth-stage data processing means being programmed with a fourth program, for receiving and storing the third-stage records from the third-stage data processing means, and for processing the third-stage records to generate fourth-stage records which identify a service category for each data transmission.

11. The system of claim 10 wherein the one or more network devices includes a router.

12. The system of claim 10 wherein the first data processing means is associated with the one or more network devices.
